(19) United States
(12) Patent Application Publication
(10) Pub. No.: US 2006/0068151 A1
(43) Pub. Date: Mar. 30, 2006

(54) Optical recording media

(76) Inventors: Sumio Ashida, Yokohama-shi (JP); Tsukasa Nakai, Hino-shi (JP); Keiichiro Yusu, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/179,597

(22) Filed: Jul. 13, 2005

(30) Foreign Application Priority Data
Sep. 30, 2004 (JP) 2004-287391

(51) Int. Cl. B32B 3/02

(52) U.S. Cl. 428/64.1

(57) ABSTRACT

An optical recording media includes a recording film, and a stacked film of at least two dielectric films A and B formed on at least one surface of the recording film. Each of the dielectric films A and B contains as a main component a compound selected from the group consisting of an inorganic oxide, an inorganic nitride, an inorganic sulfide and an inorganic fluoride or a mixture thereof, and the refractive indexes nA and nB of the dielectric films A and B satisfy the following relationship:
(nA−nB)/(nA+nB)≦0.05.

### CROSS-REFERENCE TO RELATED APPLICATIONS

This application is based upon and claims the benefit of priority from prior Japanese Patent Application No. 2004-287391, filed Sep. 30, 2004, the entire contents of which are incorporated herein by reference.

### BACKGROUND OF THE INVENTION

1. Field of the Invention

The present invention relates to an optical recording media for recording information in the form of the change of state of the recording layer upon irradiation with a light beam.

2. Description of the Related Art

Structures of known rewritable and write-once optical recording media will be described briefly.

CD-R has a structure that a recording film and a reflective film are stacked on a substrate. DVD-RW has a structure that a transparent dielectric film, a recording film, another transparent dielectric film and a reflective film are stacked on a substrate.

An example of known HD DVD has a structure that a transparent dielectric film having a high refractive index, a transparent dielectric film having a low refractive index, a transparent dielectric film having a high refractive index, a recording film, another transparent dielectric film, and a reflective film are stacked on a substrate (see Ohkubo et al., preprints of the 14th Symposium on Phase Change Optical information Storage, p. 92, 2002).

An example of known DVD-RAM has a structure that a transparent dielectric film, an interface film, a recording film, another interface film, another transparent dielectric film, an absorbance control film and a reflective film are stacked on a substrate (see Kitaura et al., preprints of the 11th Symposium on Phase Change Optical information Storage, p. 89, 1999).

In these optical recording media, the films on both side of the recording film are formed of a material having high thermal conductivity. As a result, the heat imparted by laser beam irradiation is greatly diffused. Thus, these optical recording media have a problem that sufficient sensitivity cannot be obtained depending on recording conditions, resulting in failure to form satisfactory recording marks. The problem becomes particularly serious in the case of recording at a high linear velocity or in the case of recording by use of a low power laser. Incidentally, the problem cannot be solved merely through use of a high power laser, because such a laser is costly.

Further, in the case where recording is performed in a dual-layer, single-sided disc (see, for example, Tsukamoto et al., preprints of the 14th Symposium on Phase Change Optical information Storage, p. 20, 2002) by irradiating a second information layer with a light beam passing through a first information layer arranged on the light incident side, the light intensity is expected to be considerably attenuated before reaching the second information layer because the first information layer absorbs light to some extent. Therefore, the second information layer is also subjected to the serious problem that sufficient sensitivity cannot be obtained due to thermal diffusion in the films on both sides of the recording layer, resulting in failure to form satisfactory recording marks.

### BRIEF SUMMARY OF THE INVENTION

An optical recording media according to an aspect of the present invention comprises a recording film; and a stacked film of at least two dielectric films A and B formed on at least one surface of the recording film, each of the dielectric films A and B containing as a main component a compound selected from the group consisting of an inorganic oxide, an inorganic nitride, an inorganic sulfide and an inorganic fluoride or a mixture thereof, and the refractive indexes nA and nB of the dielectric films A and B satisfying the following relationship:
(nA−nB)/(nA+nB)≦0.05.

### BRIEF DESCRIPTION OF THE SEVERAL VIEWS OF THE DRAWING

FIG. 1 is a cross-sectional view showing an example of an optical recording media according to embodiments of the present invention;

FIG. 2 is a cross-sectional view showing another example of an optical recording media according to embodiments of the present invention;

FIG. 3 is a cross-sectional view showing another example of an optical recording media according to embodiments of the present invention;

FIG. 4 is a cross-sectional view showing another example of an optical recording media according to embodiments of the present invention;

FIG. 5 is a cross-sectional view showing another example of an optical recording media according to embodiments of the present invention;

FIG. 6 is a cross-sectional view showing another example of an optical recording media according to embodiments of the present invention;

FIG. 7 is a cross-sectional view showing another example of an optical recording media according to embodiments of the present invention;

FIG. 8 is a cross-sectional view showing another example of an optical recording media according to embodiments of the present invention;

FIG. 9 shows a write strategy for the optical recording media according to embodiments of the present invention;

FIG. 10 is a graph showing the relationship between write power and CNR in respect of each of the optical recording media according to Example and Comparative Example 1; and

FIG. 11 is a graph showing the relationship between write power and CNR in respect of each of the optical recording media according to Example and Comparative Example 2.

### DETAILED DESCRIPTION OF THE INVENTION

Heat conduction can be explained by transmission of lattice vibration of a substance and motion of electrons. However, it was difficult in the past to measure accurately interfacial heat conduction between different kinds of materials. There was no report of heat conduction at the interface of the film materials in the optical recording media.

Under the circumstances, the present inventors have examined heat conduction in nanometer thin films by irradiating the film surface with a laser beam in very short pulses of 10⁻¹² second order. As a result, it has been found that, in a stacked structure of thin films each having a thickness of 10 to 100 nm, the heat conductivity of the thin film itself is substantially equal to the thermal resistance generated at the interface between two kinds of films formed of different materials.

In the optical recording media according to embodiments of the present invention, each of the dielectric films included in a stacked film of at least two dielectric films formed on one surface or both surfaces of the recording film, as viewed from the light incident side, contains as a main component a compound selected from the group consisting of an inorganic oxide, an inorganic nitride, an inorganic sulfide and an inorganic fluoride or a mixture thereof. The inorganic oxide is selected from the group consisting of Hf—O, Zr—O, Y—O, Cr—O, Nb—O, Ta—O, In—O, Al—O, Ti—O, Sn—O, Mg—O, Ce—O, Bi—O, Ga—O and Si—O. The inorganic nitride is selected from the group consisting of Si—N, Ge—N, Sn—N, B—N, C—N and Al—N. The inorganic sulfide includes, for example, Zn—S. The inorganic fluoride is selected from the group consisting of Mg—F and Ca—F. To be more specific, the inorganic oxide is selected from the group consisting of HfO₂, Al₂O₃, TiO₂, ITO, MgO, CeO₂, Bi₂O₃ and SiO₂. The inorganic nitride is selected from the group consisting of SiN and AlN. The inorganic sulfide includes, for example, ZnS. The inorganic fluoride is selected from the group consisting of MgF₂ and CaF₂. Incidentally, inorganic carbide such as SiC may be further mixed to the aforementioned compound or the mixture thereof.

In particular, it has been found that the thermal resistance at the interface is prominently high in the case where different kinds of the dielectric materials forming the stacked film are selected from (1) an oxide of Group 2 to Group 16 elements, (2) a nitride of Group 13 to Group 16 elements, and (3) a sulfide of Group 12 to Group 16 elements, and used in the form of a combination of (1) and (2), (1) and (3), or (2) and (3). It is possible to obtain effective heat conductivity lower than that of conventional dielectric materials by selecting, in this fashion, the appropriate dielectric materials for the stacked film. It follows that, if a stacked film of above different kinds of dielectric materials is formed on both surfaces or one surface of a recording film, the heat absorbed in the recording film is less diffused so as to elevate the temperature of the recording film effectively. In other words, the recording can be, performed even with low laser power.

On the other hand, where the refractive indexes of these different kinds of dielectric materials markedly differ from each other, incident light is remarkably reflected at the interface. However, where these different kinds of dielectric materials have substantially equal refractive index, the light reflection at the interface is negligible so as to make it possible to utilize the incident light power most effectively. For application of an optical recording media, different kinds of materials A and B can be considered to have substantially equal refractive index in the case of satisfying the relationship of (nA−nB)/(nA+nB)≦0.05, where nA and nB represent the refractive indexes of materials A and B, respectively. In this case, the light reflection at the interface is substantially negligible so as to make it possible to ensure sensitivity of the recording film.

In the optical recording media according to embodiments of the present invention, the recording film may be formed of a phase change recording film (for example, GeSbTe, AgInSbTe, AgInSbTeV, GeSbTeBi, GeSbTeSn, GeBiTe, etc.), a dye film, an inorganic film such as PdTeOₓ, PdOₓ, PtOₓ, Te—C, Cu/Si stacked film, and an AlSi film. In short, it is apparent that the present invention can be applied to the case where light is absorbed by the recording film and heat is generated therein thereby recording is performed.

In the optical recording media according to embodiments of the present invention, it is not necessary to use a reflective film. However, it is desirable to use a reflective film formed of, for example, Al-based or Ag-based metal in order to ensure sufficient reflectance and, thus, to obtain satisfactory read signals. Further, it is most desirable that the stacked dielectric film according to embodiments of the present invention be interposed between the recording film and the reflective film.

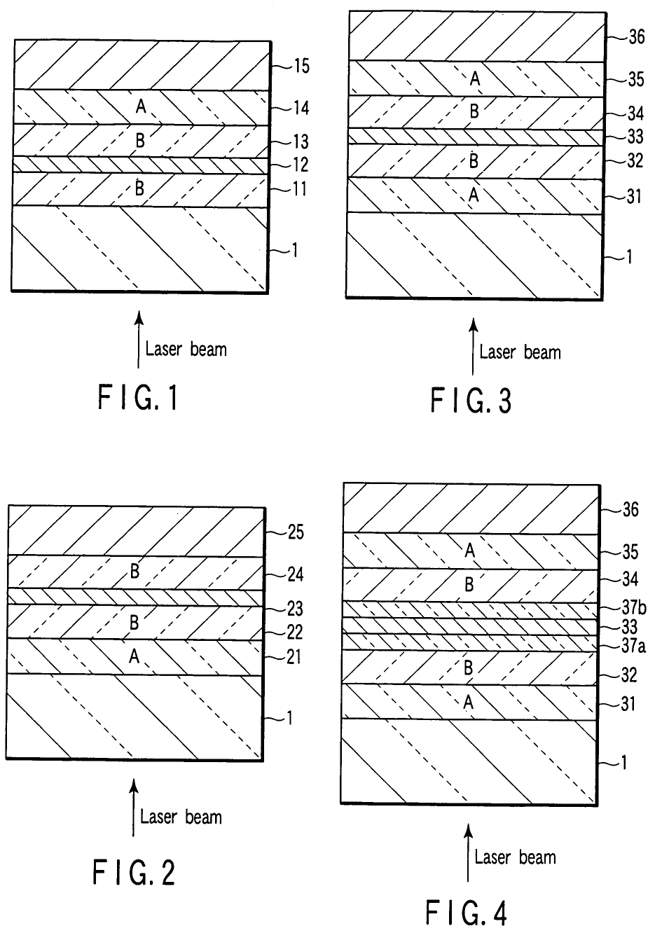

The examples of optical recording media according to embodiments of the present invention will be described with reference to FIGS. 1 to 8. Naturally, the optical recording media according to embodiments of the present invention are not limited to those examples.

The optical recording media shown in FIG. 1 has a structure that, on the transparent substrate such as the polycarbonate (PC) substrate 1, the transparent dielectric film (B) 11, the recording film 12, the transparent dielectric film (B) 13, the transparent dielectric film (A) 14 and the reflective film 15 are stacked as viewed from the light incident side. In the optical recording media shown in FIG. 1, the stacked film of the transparent dielectric film (B) 13 and the transparent dielectric film (A) 14 is formed between the recording film 12 and the reflective film 15.

The optical recording media shown in FIG. 2 has a structure that, on the PC substrate 1, the transparent dielectric film (A) 21, the transparent dielectric film (B) 22, the recording film 23, the transparent dielectric film (B) 24 and the reflective film 25 are stacked. In the optical recording media shown in FIG. 2, the stacked film of the transparent dielectric film (A) 21 and the transparent dielectric film (B) 22 is formed on the light incident side of the recording film 23.

The optical recording media shown in FIG. 3 has a structure that, on the PC substrate 1, the transparent dielectric film (A) 31, the transparent dielectric film (B) 32, the recording film 33, the transparent dielectric film (B) 34, the transparent dielectric film (A) 35 and the reflective film 36 are stacked. In the optical recording media shown in FIG. 3, the stacked films each consisting of the transparent dielectric film (A) and the transparent dielectric film (B) are formed on both sides of the recording film 33.

The optical recording media shown in FIG. 4 has a structure that the interface films 37a and 37b are formed on both sides of the recording film 33 in addition to the structure of the optical recording media shown in FIG. 3. The interface films 37a and 37b are formed of a material effective for promoting crystallization of the phase change recording film such as GeN, SiN or SiC.

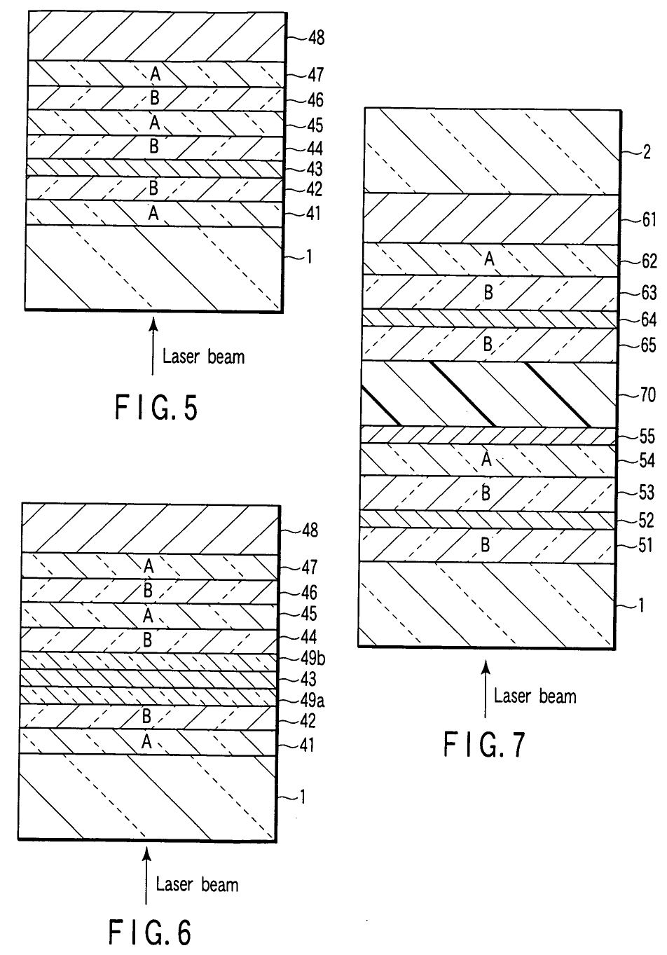

The optical recording media shown in FIG. 5 has a structure that, on the PC substrate 1, the transparent dielectric film (A) 41, the transparent dielectric film (B) 42, the recording film 43, the transparent dielectric film (B) 44, the transparent dielectric film (A) 45, the transparent dielectric film (B) 46, the transparent dielectric film (A) 47 and the reflective film 48 are stacked.

The optical recording media shown in FIG. 6 has a structure that the interface films 49a and 49b are formed on both sides of the recording film 33 in addition to the structure of the optical recording media shown in FIG. 5.

The optical recording media shown in FIG. 7 is a dual-layer, single-sided disc. On one PC substrate 1, the transparent dielectric film (B) 51, the recording film 52, the transparent dielectric film (B) 53, the transparent dielectric film (A) 54 and the semi-transparent reflective film 55 are stacked. On another PC substrate 2, the reflective film 61, the transparent dielectric film (A) 62, the transparent dielectric film (B) 63, the recording film 64 and the transparent dielectric film (B) 65 are stacked. These two substrates 1 and 2 are faced to each other with disposing film deposition surfaces inside, and are bonded with the intermediate separating layer 70 formed of a UV cure resin.

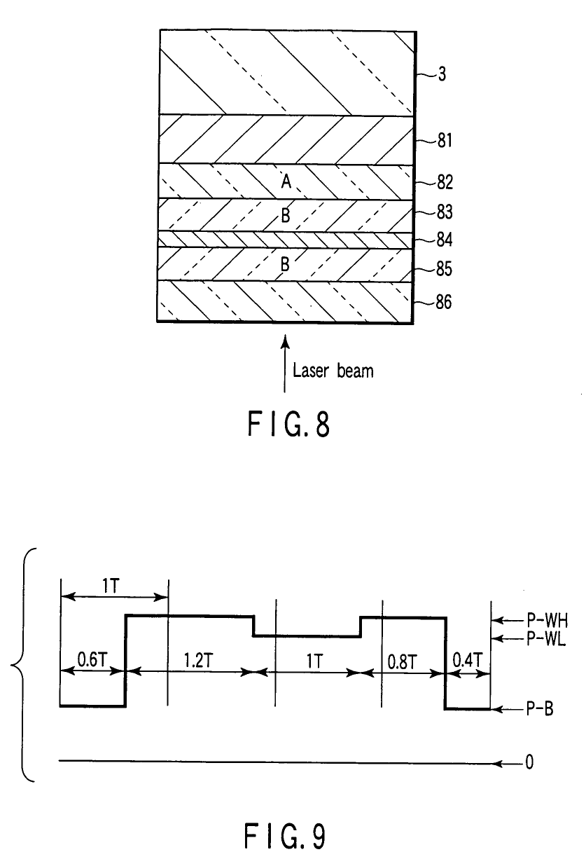

The optical recording media shown in FIG. 8 has a structure that, on the PC substrate 3, the reflective film 81, the transparent dielectric film (A) 82, the transparent dielectric film (B) 83, the recording film 84, the transparent dielectric film (B) 84 and the cover sheet 86 are stacked. In this optical recording media, a laser beam is incident on the side of the cover sheet 86 through an objective lens having a high numerical aperture (NA).

The method of selecting a combination of the different materials used for the transparent dielectric film (A) and the transparent dielectric film (B) as shown in FIGS. 1 to 8 will be described. Here, a mixture of inorganic materials is prepared using the inorganic oxides, the inorganic nitrides, the inorganic sulfide or the inorganic fluorides given below so as to permit the mixture to exhibit a refractive index equal to that of another compound or a mixed compound.

Examples of oxides are Al₂O₃ (refractive index of 1.67), TiO₂ (refractive index of 2.8), ITO, i.e., In₂O₃—SnO₂ composite oxide (refractive index of 1.8), MgO (refractive index of 1.7), CeO₂ (refractive index of 2.4), Bi₂O₃ (refractive index of 2.5), and SiO₂ (refractive index of 1.48);

an example of sulfide is ZnS (refractive index of 2.4);

examples of nitrides are SiN (refractive index of 2), and AlN (refractive index of 2.2); and

examples of fluorides are MgF₂ (refractive index of 1.38), and CaF₂ (refractive index of 1.44).

Table 1 shows examples of transparent dielectric materials containing the inorganic compounds exemplified above and having a refractive index (or resultant refractive index) of 2, and Table 2 shows examples of transparent dielectric materials containing the inorganic compounds exemplified above and having a refractive index (or resultant refractive index) of 2.2.

Two of the compounds 1-1 to 1-4 shown in Table 1 can be selected for the combination of the transparent dielectric film (A) and the transparent dielectric film (B) shown in each of FIGS. 1 to 8. Likewise, two of the compounds 2-1 to 2-4 shown in Table 2 can be selected for the combination of the transparent dielectric film (A) and the transparent dielectric film (B) shown in each of FIGS. 1 to 8.

Incidentally, it is not necessary that the compounds shown in Tables 1 and 2 have a stoichiometric composition. It suffices for the compounds to have a refractive index falling within the range specified in the present invention and to be substantially transparent to the wavelength of the light source employed. It is not necessary for the compound represented by SiO₂ in Table 2, for example, to have Si:O atomic ratio of an integer ratio of 1:2 as a result of analysis. The atomic ratio may be varied within a range of 1:1.9 to 1:2.1.

Also, it is not necessary that the compound for the transparent dielectric film be a pure substance or a mixture of pure substances consisting of an oxide alone, a nitride alone, a sulfide alone or a fluoride alone. For example, the transparent dielectric film may be formed of a mixture an oxide and a fluoride such as Compound 1-3 shown in Table 1 and Compound 2-3 shown in Table 2, or a mixture of a sulfide and an oxide such as Compound 2-1 shown in Table 2. In such a case, attention should be paid to the compound used as a main component, i.e., the compound contained in an amount of 50 atomic % or more. For example, where an oxide is used as the main component, it is desirable to use another material selected from the group consisting of a nitride, a fluoride or a sulfide in combination with the oxide.

TABLE 1
Transparent dielectric material with a refractive
index (or a resultant refractive index) of 2

| | refractive index | | atomic % | |
|---|---|---|---|---|
| Compound | TiO₂ | Al₂O₃ | TiO₂ | Al₂O₃ |
| 1-1 | 2.8 | 1.67 | 29% | 71% |
| Compound | CeO₂ | Al₂O₃ | CeO₂ | Al₂O₃ |
| 1-2 | 2.4 | 1.67 | 45% | 55% |
| Compound | CeO₂ | MgF₂ | CeO₂ | MgF₂ |
| 1-3 | 2.4 | 1.38 | 61% | 39% |
| Compound | SiN | — | SiN | — |
| 1-4 | 2 | — | 100% | — |

TABLE 2
Transparent dielectric material with a refractive
index (or a resultant refractive index) of 2.2

| | refractive index | | atomic % | |
|---|---|---|---|---|
| Compound | ZnS | SiO₂ | ZnS | SiO₂ |
| 2-1 | 2.4 | 1.67 | 78% | 22% |
| Compound | CeO₂ | Al₂O₃ | CeO₂ | Al₂O₃ |
| 2-2 | 2.4 | 1.67 | 73% | 27% |
| Compound | CeO₂ | MgF₂ | CeO₂ | MgF₂ |
| 2-3 | 2.4 | 1.38 | 80% | 20% |
| Compound | AlN | — | AlN | — |
| 2-4 | 2.2 | — | 100% | — |

As described above, the optical recording media according to the embodiments of the present invention comprises, on both surfaces or one surface of a recording film, a stacked film of a transparent dielectric film (A) and a transparent dielectric film (B) which are different materials but equal to each other in refractive index. The particular construction permits lowering heat conductivity while ensuring the optical characteristics substantially equal to those of the prior art so as to make it possible to provide a high-sensitive optical recording media.

### EXAMPLES

Optical recording media for an Example of the present invention, Comparative Example 1 and Comparative Example 2 were manufactured as follows.

A polycarbonate substrate having a thickness of 0.6 mm with pre-grooves was prepared. The pre-grooves was formed so as to perform land-groove recording with a track pitch of 0.34 μm. On the polycarbonate substrate, a first dielectric film, a phase change recording film of AgInSbTe, a second dielectric film and a reflective film of AgNdCu were deposited successively by magnetron sputtering. The materials given below were used for the first dielectric film and the second dielectric film on both sides of the recording film. These dielectric films were formed by RF magnetron sputtering using a composite target.

### EXAMPLE

An optical recording media shown in FIG. 3 was manufactured by using the following transparent dielectric films for the first dielectric film and the second dielectric film:

a transparent dielectric film A formed of a mixture of ZnS (80 atomic %) and SiO₂, resultant refractive index of which is about 2.2; and

a transparent dielectric film B formed of a mixture of HfO₂ (95 atomic %) and SiC, resultant refractive index of which is about 2.2.

In this case, the value of (nA−nB)/(nA+nB) was substantially equal to zero.

### Comparative Example 1

A conventional optical recording media was manufactured by using only a transparent dielectric film of a mixture of ZnS (80 atomic %) and SiO₂ for each of the first dielectric film and the second dielectric film.

### Comparative Example 2

An optical recording media shown in FIG. 3 was manufactured by using the following transparent dielectric films for the first dielectric film and the second dielectric film:

a transparent dielectric film A formed of a mixture of ZnS (80 atomic %) and SiO₂, resultant refractive index of which is about 2.2; and

a transparent dielectric film B formed of a mixture of CeO₂ (70 atomic %) and Al₂O₃, resultant refractive index of which is about 1.98.

In this case, (nA−nB)/(nA+nB)≈0.07>0.05.

Each of these optical recording media was evaluated by using an evaluating apparatus DDU-1000 manufactured by Pulstec Industrial Co., Ltd. The evaluating apparatus includes a laser diode with a wavelength of 405 nm as the light source and a pick-up provided with an objective lens with a numerical aperture NA of 0.65. The laser diode used as the light source provides the maximum power of 15 mW on the recording media by pulsed irradiation in the recording stage.

In order to examine whether it is possible to perform high-speed recording, recording experiments were conducted under a linear velocity of 11.2 m/s or 22.4 m/s by varying the spindle rotating speed of the evaluating apparatus. The recording was performed by irradiation with a laser beam modulated into a simple pulse train. FIG. 9 shows the write strategy. Also, Table 3 shows the values of each of the parameters shown in FIG. 9, covering the cases where the linear velocity was set at 11.2 m/s and 22.4 m/s, respectively. After the recording, the recorded information was read under a read power Pr of 0.5 mW to measure a carrier-to-noise ratio (CNR).

TABLE 3

linear velocity

| | 11.2 m/s | 22.4 m/s |
|---|---|---|
| 1T | 7.7 ns | 3.9 ns |
| P-WH | variable | variable |
| P-WL | 0.6 × P-WH | 0.8 × P-WH |
| P-B | 0.3 × P-WH | 0.3 × P-WH |

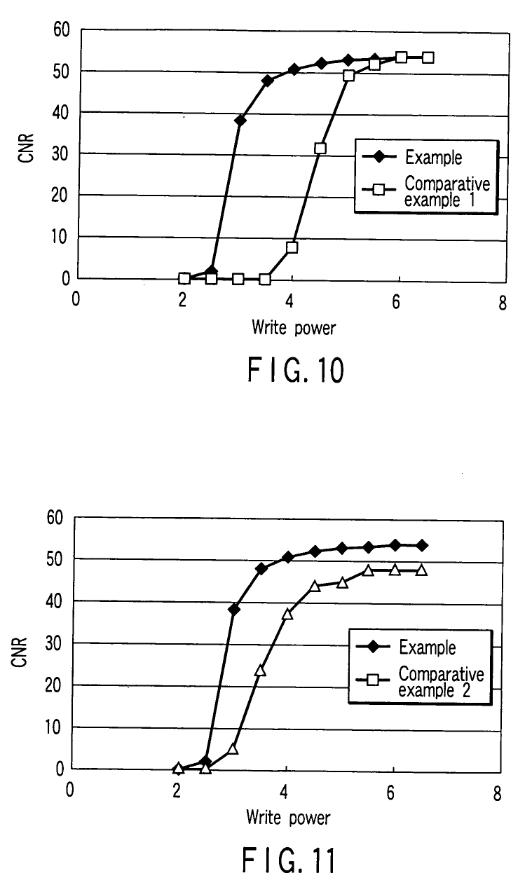

FIG. 10 is a graph showing the relationship between the write power and CNR, covering the case where recording was performed under a linear velocity of 22.4 m/s in each of the optical recording media of Example and Comparative Example 1. FIG. 10 gives the followings.

The optical recording media of Comparative Example 1 required a write power of 5.5 mW for saturation of CNR. In contrast, the optical recording media of Example required a low write power of 3.5 mW for saturation of CNR. Thus, when recording was performed with rotating the conventional optical recording media at a high linear velocity, a high level of write power is required for providing a sufficient CNR. Incidentally, it was found that even the optical recording media of Comparative Example 1 could provide CNR of 52 dB with a write power of 3.5 mW under a linear velocity of 11.2 m/s, which shows that a low linear velocity permits improving sensitivity. Comparison between the both cases clearly supports that the structure of the optical recording media according to the present Example is highly effective in the case where an operation at a high linear velocity is required for high-speed recording.

FIG. 11 is a graph showing the relationship between the write power and CNR, covering the case where recording was performed under a linear velocity of 22.4 m/s in each of the optical recording media of Example and Comparative Example 2. FIG. 11 gives the followings.

As is apparent from comparison with FIG. 10, the optical recording media of Comparative Example 2 was superior in sensitivity to the optical recording media of Comparative Example 1. However, the optical recording media of Comparative Example 2 had a low saturation value of CNR, indicating insufficient quality of read signals. This is because light reflection is caused at the interface between the transparent dielectric film A (the mixture of ZnS (80 at %) and SiO₂) and the transparent dielectric film B (the mixture of CeO₂ (70 at %) and Al₂O₃), lowering the degree of signal modulation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical recording media comprising:
a recording film; and
a stacked film of at least two dielectric films A and B formed on at least one surface of the recording film, each of the dielectric films A and B containing as a main component a compound selected from the group consisting of an inorganic oxide, an inorganic nitride, an inorganic sulfide and an inorganic fluoride or a mixture thereof, and the refractive indexes nA and nB of the dielectric films A and B satisfying the following relationship:
(nA−nB)/(nA+nB)≦0.05.

2. The optical recording media according to claim 1, wherein the inorganic oxide is selected from the group consisting of Hf—O, Zr—O, Y—O, Cr—O, Nb—O, Ta—O, In—O, Al—O, Ti—O, Sn—O, Mg—O, Ce—O, Bi—O, Ga—O and Si—O, the inorganic nitride is selected from the group consisting of Si—N, Ge—N, Sn—N, B—N, C—N and Al—N, the inorganic sulfide is Zn—S, and the inorganic fluoride is selected from the group consisting of Mg—F and Ca—F.

3. The optical recording media according to claim 1, wherein the stacked film of at least two dielectric films comprises a combination of an oxide of Group 2 to Group 16 elements and a nitride of Group 13 to Group 16 elements.

4. The optical recording media according to claim 1, wherein the stacked film of at least two dielectric films comprises a combination of an oxide of Group 2 to Group 16 elements and a sulfide of Group 12 to Group 16 elements.

5. The optical recording media according to claim 1, wherein the stacked film of at least two dielectric films comprises a combination of a nitride of Group 13 to Group 16 elements and a sulfide of Group 12 to Group 16 elements.

6. The optical recording media according to claim 1, wherein the stacked film of at least two dielectric films comprises a combination of materials selected from the group consisting of a mixture of TiO₂ and Al₂O₃, a mixture of CeO₂ and Al₂O₃, a mixture of CeO₂ and MgF₂, and SiN.

7. The optical recording media according to claim 1, wherein the stacked film of at least two dielectric films comprises a combination of materials selected from the group consisting of a mixture of ZnS and SiO₂, a mixture of CeO₂ and Al₂O₃, a mixture of CeO₂ and MgF₂, a mixture of HfO₂ and SiC, and AlN.

8. The optical recording media according to claim 1, wherein the recording film is formed of a phase change recording film selected from the group consisting of GeSbTe, AgInSbTe, AgInSbTeV, GeSbTeBi, GeSbTeSn and GeBiTe.

9. The optical recording media according to claim 1, wherein the media has a structure that a transparent substrate, a single film of a transparent dielectric film, the recording film, the stacked film of at least two transparent dielectric films, and a reflective film are stacked, as viewed from a light incident side.

10. The optical recording media according to claim 1, wherein the media has a structure that a transparent substrate, the stacked film of at least two transparent dielectric films, the recording film, a single film of a transparent dielectric film, and a reflective film are stacked, as viewed from a light incident side.

11. The optical recording media according to claim 1, wherein the media has a structure that a transparent substrate, the stacked film of at least two transparent dielectric films, the recording film, the stacked film of at least two transparent dielectric films, and a reflective film are stacked, as viewed from a light incident side.

12. The optical recording media according to claim 1, wherein the media comprises a transparent substrate, a first information layer formed on the transparent substrate and a second information layer formed on the first information layer, the first information layer having a structure that a single film of a transparent dielectric film, the recording film, the stacked film of at least two transparent dielectric films, and a reflective film are stacked, and the second information layer having a structure that a single film of a transparent dielectric film, the recording film, the stacked film of at least two transparent dielectric films, and a reflective film are stacked, as viewed from a light incident side.

13. The optical recording media according to claim 1, wherein the media has a structure that a cover sheet, a single layer of a transparent dielectric film, the recording film, the stacked layer of at least two transparent dielectric films, a reflective film, and a transparent substrate are stacked, as viewed from a light incident side.

14. The optical recording media according to claim 1, further comprising interface films formed on both surfaces of the recording film.

15. The optical recording media according to claim 14, wherein the interface film is formed of a material selected from the group consisting of GeN, SiN and SiC.
